(19) United States
(12) Patent Application Publication
(10) Pub. No.: US 2019/0263014 A1
(43) Pub. Date: Aug. 29, 2019

(54) CUTTING METHOD AND CUTTING TOOL

(71) Applicant: JTEKT CORPORATION, Osaka-shi (JP)

(72) Inventors: Hiroshi WATANABE, Nagoya-shi (JP); Takayuki AZUMA, Anjo-shi (JP); Yusuke KITO, Nisshin-shi (JP)

(73) Assignee: JTEKT CORPORATION, Osaka-shi (JP)

(21) Appl. No.: 16/282,806

(22) Filed: Feb. 22, 2019

(30) Foreign Application Priority Data
Feb. 27, 2018 (JP) 2018-033298
Feb. 27, 2018 (JP) 2018-033299

(51) Int. Cl. B27B 5/29

(52) U.S. Cl. CPC B27B 5/29; C23C 18/08

(57) ABSTRACT

A cutting method for cutting a workpiece by using a cutting tool having a ring-shaped cutting edge, the workpiece containing alumina, the cutting method includes: cutting the workpiece with the cutting edge being coated with alumina contained in the workpiece, wherein an end surface of the cutting tool is set as a flank, and an outer circumferential surface of the cutting tool is set as a rake face.

### INCORPORATION BY REFERENCE

The disclosure of Japanese Patent Application No. 2018-033298 filed on Feb. 27, 2018 and Japanese Patent Application No. 2018-033299 filed on Feb. 27, 2018, each including the specification, drawings and abstract, is incorporated herein by reference in its entirety.

### BACKGROUND

### 1. Technical Field

The disclosure relates to a cutting method and a cutting tool.

### 2. Description of Related Art

In Japanese Patent Application Publication No. 2017-7003 (JP 2017-7003 A), a technique of cutting a cylindrical workpiece while rotating a cutting tool having a ring-shaped cutting edge whose outer circumferential surface is set as a rake face (hereinafter simply referred to as a “cutting tool” or a “ring-shaped tool”) is described. In this cutting work using the ring-shaped tool, the cutting work is performed while the ring-shaped tool is rotated. In this way, cutting heat generated in the cutting edge is dispersed for the entire outer circumferential surface, which extends the tool life. The cutting work is performed while the ring-shaped tool is rotated with an end surface of the ring-shaped tool being set as a flank.

### SUMMARY

In the above related art, highly-efficient cutting work can be performed by rotating the cutting tool and the workpiece at a high speed. Meanwhile, the cutting heat generated during cutting is increased as the cutting work is performed with higher efficiency. As a result, the cutting tool is worn sooner and shortens the tool life. In addition, in the above related art, a deposited material is deposited on an edge of the ring-shaped tool during cutting. The deposited material deposited on the edge of the ring-shaped tool prevents transfer of the cutting heat, which is generated in a worked portion during cutting, to the edge. Meanwhile, when the deposited material deposited on the end surface of the ring-shaped tool comes into contact with a worked surface of the workpiece, abrasions are produced on the worked surface and deteriorate surface roughness of the worked surface. In addition, the heat, which is generated in the worked surface of the workpiece due to the contact with the deposited material, generates residual stress in a tensile direction on the worked surface and thus becomes a cause to lower quality of the workpiece.

The disclosure provides a cutting method and a cutting tool capable of achieving both of improvement in working efficiency and extension of tool life.

A first aspect of the present disclosure relates to a cutting method for cutting a workpiece by using a cutting tool having a ring-shaped cutting edge, the workpiece containing alumina, the cutting method including: cutting the workpiece with the cutting edge being coated with alumina contained in the workpiece, wherein an end surface of the cutting tool is set as a flank, and an outer circumferential surface of the cutting tool is set as a rake face.

In the cutting method according to the above aspect, the workpiece is cut while alumina contained in the workpiece coats the cutting edge. Accordingly, even in the case where cutting heat, which is generated in a worked portion during cutting work, is increased by setting a rotation speed and a feed speed of the cutting tool at the high speeds, it is possible to suppress transfer of the cutting heat to the cutting edge. That is, in the cutting method according to the above aspect, wear of the cutting tool can be suppressed while the rotation speed and the feed speed of the cutting tool are set to be high. Therefore, it is possible to achieve both of improvement in working efficiency and extension of tool life.

In the above first aspect, the workpiece may contain γ-alumina, and when the workpiece is cut by the cutting edge, heat at a temperature exceeding a temperature at which γ-alumina is transformed into α-alumina may be generated.

In the above aspect, the cutting method may further include cutting the workpiece with the outer circumferential surface being coated with alumina.

In the above aspect, the cutting method may further include cutting the workpiece with the end surface of the cutting tool being coated with alumina.

In the above first aspect, the end surface of the cutting tool may be mirror finished.

In the cutting method according to the above aspect, the workpiece is cut while alumina contained in the workpiece coats the cutting edge. In this way, it is possible to suppress the transfer of the cutting heat, which is generated during the cutting work, to the cutting tool. Thus, in the above cutting method, the early wear of the cutting tool can be suppressed. Meanwhile, in the above cutting method, the end surface of the cutting tool is mirror-finished. Accordingly, it is possible to suppress a deposited material from being deposited on the end surface during the cutting work. In this way, in the above cutting method, it is possible to suppress contact between the deposited material deposited on the end surface and a worked surface of the workpiece. Thus, surface roughness of the worked surface of the workpiece can be improved.

In the above cutting method, it is possible to suppress generation of abrasive heat resulted from the contact between the deposited material deposited on the end surface and the worked surface of the workpiece. Thus, it is possible to suppress generation of residual stress in a tensile direction on the worked surface.

In the above aspect, surface roughness of the end surface may be less than surface roughness of the outer circumferential surface.

In the above first aspect, the end surface of the cutting tool may be inclined such that a clearance between the end surface and a plane that is orthogonal to a rotation axis of the cutting tool and includes the ring-shaped cutting edge increases toward a radially inward side of the cutting tool.

In the above cutting method, the workpiece is cut while alumina contained in the workpiece coats the cutting edge. In this way, it is possible to suppress the transfer of the cutting heat, which is generated during the cutting work, to the cutting edge. Thus, in the above cutting method, it is possible to suppress the early wear of the cutting tool. Meanwhile, in the above cutting method, the end surface of the cutting tool is inclined in such a manner as to increase the clearance between the end surface and the plane that is orthogonal to the rotation axis of the cutting tool and includes the cutting edge as the end surface is directed inward in the radial direction of the cutting tool. Thus, it is possible to set a clearance angle that is defined by the end surface and the worked surface of the workpiece to a large angle.

In this way, in the above cutting method, it is possible to suppress the deposited material from being deposited on the end surface during the cutting work.

Accordingly, in the above cutting method, it is possible to suppress the contact between the deposited material deposited on the end surface and the worked surface of the workpiece. Thus, the surface roughness of the worked surface of the workpiece can be improved. In addition, in the above cutting method, it is possible to suppress generation of abrasive heat resulted from the contact between the deposited material deposited on the end surface and the worked surface of the workpiece. Thus, it is possible to suppress generation of residual stress in a tensile direction on the worked surface.

In the above first aspect, the cutting method may further include setting a posture of the cutting tool with respect to the workpiece such that a clearance angle between the end surface and the workpiece becomes equal to or larger than a specified angle.

In the above cutting method, the workpiece is cut while alumina contained in the workpiece coats the cutting edge. In this way, it is possible to suppress the transfer of the cutting heat, which is generated during the cutting work, to the cutting edge. Thus, in the above cutting method, it is possible to suppress the early wear of the cutting tool. Meanwhile, in the above cutting method, the posture of the cutting tool with respect to the workpiece is set such that the clearance angle defined by the end surface of the cutting tool and the workpiece becomes equal to or larger than the specified angle. Thus, it is possible to set the clearance angle that is defined by the end surface and the workpiece to the large angle.

In this way, in the above cutting method, it is possible to suppress the deposited material from being deposited on the end surface during the cutting work. Accordingly, in the above cutting method, it is possible to suppress the contact between the deposited material deposited on the end surface and the worked surface of the workpiece. Thus, the surface roughness of the worked surface of the workpiece can be improved. In addition, in the above cutting method, it is possible to suppress generation of abrasive heat resulted from the contact between the deposited material deposited on the end surface and the worked surface of the workpiece. Thus, it is possible to suppress generation of residual stress in a tensile direction on the worked surface.

In the above first aspect, the cutting method may further include: roughing the workpiece; and finishing the workpiece that is roughed, wherein a clearance angle when the workpiece is being finished is set to be larger than a clearance angle when the workpiece is being roughed.

A second aspect of the present disclosure relates to a cutting tool for cutting a workpiece, the cutting tool including: an outer circumferential surface as a rake face; a ring-shaped cutting edge; and an end surface as a flank when the workpiece is cut, the end surface being mirror-finished.

In the above cutting tool, the end surface is mirror-finished. Accordingly, it is possible to suppress a deposited material from being deposited on the end surface during the cutting work. Thus, the above cutting tool can improve surface roughness of the worked surface of the workpiece in the cutting work. In addition, in the above cutting tool, it is possible to suppress generation of abrasive heat resulted from the contact between the deposited material deposited on the end surface and the worked surface of the workpiece. Thus, it is possible to suppress generation of residual stress in a tensile direction on the worked surface.

In the above second aspect, surface roughness of the end surface may be less than surface roughness of the rake face.

A third aspect of the present disclosure relates to a cutting tool for cutting a workpiece, the cutting tool including: an outer circumferential surface as a rake face; a ring-shaped cutting edge; and an end surface as a flank when the workpiece is cut, wherein the end surface of the cutting tool is inclined such that a clearance between the end surface and a plane that is orthogonal to a rotation axis of the cutting tool and includes the cutting edge increases toward a radially inward side of the cutting tool.

In the above cutting tool, the end surface of the cutting tool is inclined in such a manner as to increase the clearance between the end surface and the plane that is orthogonal to the rotation axis of the cutting tool and includes the cutting edge as the end surface is directed inward in the radial direction of the cutting tool. Thus, it is possible to set a clearance angle that is defined by the end surface and the worked surface of the workpiece to a large angle.

In this way, the above cutting tool can suppress the deposited material from being deposited on the end surface during the cutting work while coating the cutting edge with alumina contained in the workpiece in the cutting work. In this case, the above cutting tool can suppress transfer of cutting heat, which is generated during the cutting work, to the cutting edge. Thus, it is possible to prevent early wear of the cutting tool. In addition, the above cutting tool can suppress generation of abrasive heat resulted from the contact between the deposited material deposited on the end surface and the worked surface of the workpiece. Thus, it is possible to suppress generation of residual stress in a tensile direction on the worked surface. Therefore, it is possible to extend life of the cutting tool and to improve quality of the workpiece that is cut.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is a plan view of an overall configuration of a cutting apparatus used for a cutting method in an embodiment of the disclosure;

FIG. 1B is a cross-sectional view of the cutting apparatus taken along line IB-IB in FIG. 1A;

FIG. 2 is an enlarged view of a ring-shaped tool, which is retained by a tool retainer, and a workpiece and shows a contact state between a cutting edge of the ring-shaped tool and the workpiece;

FIG. 3 is a block diagram of a controller;

FIG. 4A is an enlarged view of a ring-shaped tool that cuts a workpiece and in which an edge of the ring-shaped tool is enlarged;

FIG. 4B is an enlarged view of the edge of the ring-shaped tool after work;

FIG. 5A shows the ring-shaped tool in a second embodiment that cuts the workpiece;

FIG. 5B is an enlarged view of an edge of the ring-shaped tool in the second embodiment after the work;

FIG. 6 is a graph showing a relationship between residual stress and a working distance, the residual stress being generated on the worked surface of each of the workpieces that have been cut by using two ring-shaped tools having different surface roughness of end surfaces from each other, and the working distance being a distance for which each of the ring-shaped tools has performed the cutting work;

FIG. 7 shows a ring-shaped tool in a third embodiment;

FIG. 8 is an enlarged view of the ring-shaped tool and a workpiece and shows a contact state between the workpiece and a cutting edge of the ring-shaped tool retained by a tool retainer;

FIG. 9 is a graph showing a relationship between the residual stress and the working distance, the residual stress being generated on the worked surface of each of the workpieces that have been cut by different clearance angles, and the working distance being the distance for which each of the ring-shaped tools has performed the cutting work; and

FIG. 10 is an enlarged view of a ring-shaped tool and a workpiece in a modified example and shows a contact state between the workpiece and a cutting edge of the ring-shaped tool retained by a tool retainer.

### DETAILED DESCRIPTION OF EMBODIMENTS

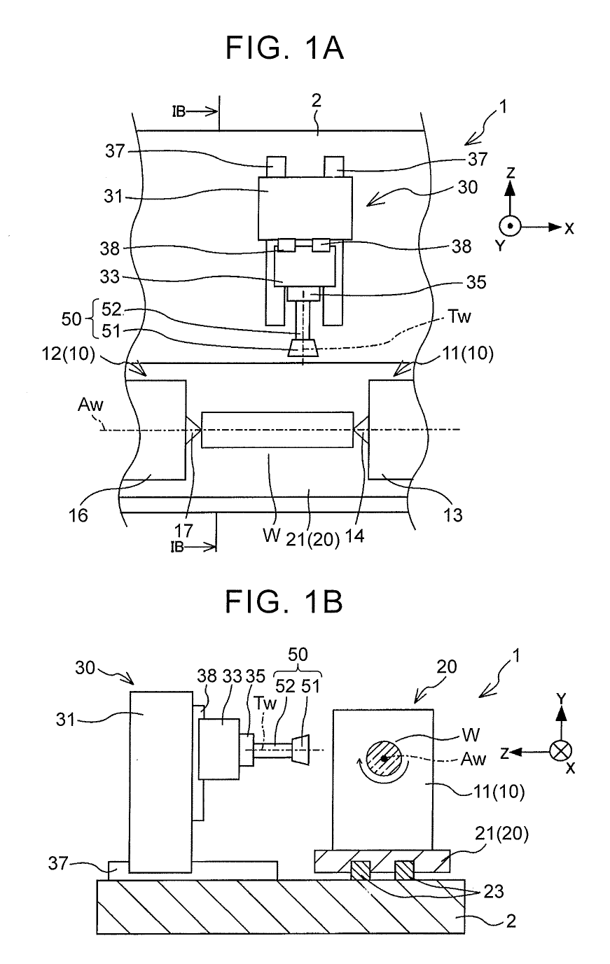

A description will hereinafter be made on embodiments, to each of which a cutting method according to the disclosure is applied, with reference to the drawings. Referring now to FIG. 1A to FIG. 3, a description will be made on a configuration of a cutting apparatus 1 used for a cutting method in a first embodiment of the disclosure.

As shown in FIG. 1A and FIG. 1B, the cutting apparatus 1 is a four-axis machining center having three linear axes (an X-axis, a Y-axis, and a Z-axis) that are orthogonal to each other and one rotational axis (an unillustrated C-axis). The cutting apparatus 1 includes a workpiece retainer 10, a workpiece feeder 20, a tool retainer 30, and a controller 100 as main components.

The workpiece retainer 10 retains a workpiece W in such a manner as to allow rotation of the workpiece W. The workpiece retainer 10 includes a headstock 11 and a tailstock 12. The headstock 11 supports an axial end side (a right side in FIG. 1A) of the workpiece W in such a manner as to allow the rotation of the workpiece W. The headstock 11 includes: a headstock body 13 as a housing; a main rotary spindle 14 that is rotatably supported by the headstock body 13; and a main rotary spindle motor 15 that applies a driving force to the main rotary spindle 14 for rotation. The tailstock 12 includes: a tailstock body 16 as a housing; and a tailstock center 17 that supports another axial end side (a left side in FIG. 1 A) of the workpiece W in such a manner as to allow the rotation of the workpiece W.

In a state where a rotation axis Aw of the workpiece W is directed in parallel with the X-axis direction, the workpiece retainer 10 supports both ends in the rotation axis Aw of the workpiece W by the main rotary spindle 14 and the tailstock center 17. The workpiece W is rotated about the rotation axis Aw when the main rotary spindle motor 15 is driven.

The workpiece feeder 20 feeds the workpiece W in the X-axis direction. The workpiece feeder 20 includes a slide 21 and an X-axis drive unit 22 (see FIG. 3). The X-axis drive unit 22 is not shown in FIG. 1A and FIG. 1B. The slide 21 is provided to be movable in the X-axis direction on an upper surface of a bed 2. More specifically, a pair of X-axis guide rails 23 extending in the X-axis direction is provided on the upper surface of the bed 2. The slide 21 is placed to be movable in the X-axis direction while being guided by the X-axis guide rails 23. The X-axis drive unit 22 is a screw feeder that feeds the slide 21 in the X-axis direction (in the rotation axis Aw direction of the workpiece W) with respect to the bed 2.

The headstock 11 and the tailstock 12 are placed on an upper surface of the slide 21. The workpiece W, which is supported by the headstock 11 and the tailstock 12, is fed in the rotation axis Aw direction of the workpiece W when the X-axis drive unit 22 is driven and moves the slide 21 in the X-axis direction.

The tool retainer 30 retains a cutting tool, which will be described later, (hereinafter referred to as a “ring-shaped tool”) 50 in such a manner as to allow rotation thereof. The tool retainer 30 includes a column 31, a Z-axis drive unit 32 (see FIG. 3), a saddle 33, a Y-axis drive unit 34 (see FIG. 3), a tool spindle 35, and a tool spindle motor 36 (see FIG. 3). The Z-axis drive unit 32 and the Y-axis drive unit 34 are not shown in FIG. 1A and FIG. 1B.

The column 31 is provided to be movable in the Z-axis direction on the upper surface of the bed 2. More specifically, a pair of Z-axis guide rails 37 extending in the Z-axis direction is provided on the upper surface of the bed 2. The column 31 is placed to be movable in the Z-axis direction while being guided by the Z-axis guide rails 37. The Z-axis drive unit 32 is a screw feeder that feeds the column 31 in the Z-axis direction with respect to the bed 2.

The saddle 33 is provided to be movable in the Y-axis direction on a lateral surface of the column 31. More specifically, a pair of Y-axis guide rails 38 extending in the Y-axis direction (a vertical direction) is provided on the lateral surface of the column 31. The saddle 33 is disposed to be movable in the Y-axis direction while being guided by the Y-axis guide rails 38. The Y-axis drive unit 34 is a screw feeder that feeds the saddle 33 in the Y-axis direction.

The tool spindle 35 is supported on the saddle 33 in a rotatable manner about an axis that is parallel with the Z-axis direction. The tool spindle motor 36 is a motor that applies a driving force to the tool spindle 35 for rotation, and is accommodated in the saddle 33. The ring-shaped tool 50 used to cut the workpiece W is detachably attached to a tip of the tool spindle 35. The ring-shaped tool 50 is rotatably retained by the tool retainer 30 and moves in parallel in the Z-axis direction and the Y-axis direction (directions orthogonal to a feeding direction) with respect to the bed 2 in conjunction with movement of the column 31 and the saddle 33.

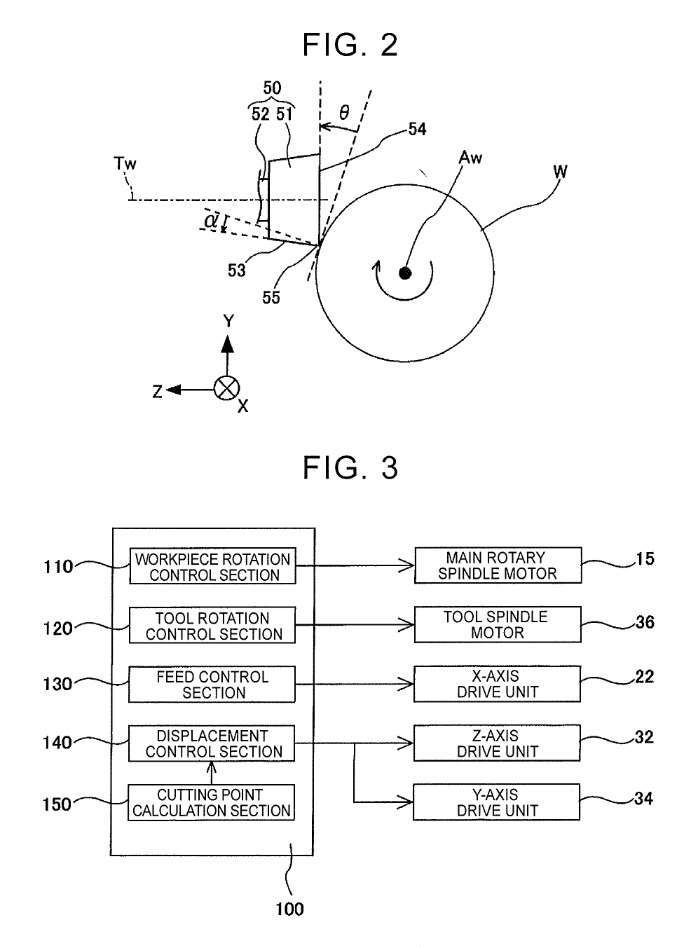

A description will herein be made on the ring-shaped tool 50 with reference to FIG. 2. As shown in FIG. 2, the ring-shaped tool 50 includes a tool body 51 and a tool shaft section 52. The tool body 51 is a portion for cutting the workpiece W and is made from cubic boron nitride (CBN). The tool body 51 is formed in a truncated cone shape, and an outer circumferential surface 53 of the tool body 51 defines a rake face. An end surface 54 on a large-diameter side of the tool body 51 is formed as a flat flank, and a ridgeline defined by the outer circumferential surface 53 and the end surface 54 serves as a cutting edge 55 in a continuous circular shape, that is, a ring shape that is not divided in the middle. The tool shaft section 52 is a cylindrical portion that extends from an end surface on a small-diameter side of the tool body 51, and is detachably attached to the tool spindle 35. A rotation axis Tw of the ring-shaped tool 50 is provided coaxially with the tool spindle 35, and the ring-shaped tool 50 is rotated about the rotation axis Tw in conjunction with the rotation of the tool spindle 35.

As shown in FIG. 3, the controller 100 includes a workpiece rotation control section 110, a tool rotation control section 120, a feed control section 130, and a displacement control section 140. The workpiece rotation control section 110 controls driving of the main rotary spindle motor 15 to rotate the workpiece W supported by the main rotary spindle 14 and the tailstock center 17. The tool rotation control section 120 controls driving of the tool spindle motor 36 to rotate the ring-shaped tool 50 attached to the tool spindle 35. The feed control section 130 controls driving of the X-axis drive unit 22 to move the slide 21 in the X-axis direction and thereby feeds the workpiece W, which is retained by the workpiece retainer 10, in the X-axis direction. The displacement control section 140 controls driving of the Y-axis drive unit 34 and the Z-axis drive unit 32 to move the ring-shaped tool 50, which is attached to the tool retainer 30, in parallel with the Y-axis direction and the Z-axis direction.

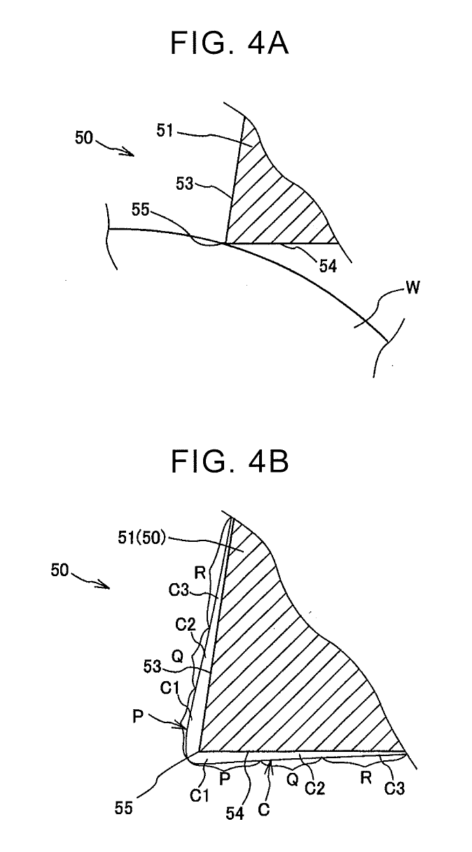

Next, referring to FIG. 4A and FIG. 4B, a description will be made on the cutting method of the workpiece W by using the cutting apparatus 1. The workpiece W is a steel material containing a slight amount of alumina as an inclusion, and an example of the workpiece W is a bearing steel. The workpiece W in this embodiment is high-carbon chromium bearing steel (for example, SUJ2 in Japanese Industrial Standards, hereinafter merely referred to as “SUJ2”) as the bearing steel that has undergone thermal treatment. More specifically, the workpiece W as SUJ2 is quenched and tempered as the thermal treatment.

As shown in FIG. 4A, the cutting apparatus 1 rotates the ring-shaped tool 50 about the rotation axis Tw while rotating the workpiece W about the rotation axis Aw. Then, the cutting apparatus 1 brings the cutting edge 55 into contact with the workpiece W while providing a specified clearance (a clearance angle θ) between the end surface 54 of the tool body 51 and the workpiece W, so as to cut the workpiece W. At this time, for example, the cutting apparatus 1 sets a rotation speed and a feed speed of the ring-shaped tool 50 such that cutting heat generated in a worked portion of the workpiece W by the ring-shaped tool 50 at least exceeds a quenching temperature of the workpiece W during cutting work.

When the workpiece W is cut by the above-described method, as shown in FIG. 4B, a component that is contained in the workpiece W during the cutting work has been melted and deposited on an edge of the tool body 51 after the work. The inventor has found that a main component of a deposited material C1 deposited in a region P was alumina, the region P including the cutting edge 55 and portions of the outer circumferential surface 53 and the end surface 54 near the cutting edge 55.

In regard to SUJ2, it is specified in JIS G 4805 (Japanese Industrial Standards) that an index of cleanliness of a non-metallic inclusion is 0.18% at maximum and that the index of cleanliness of a B-type inclusion and a C-type inclusion is 0.05 at maximum, and alumina is classified as the B-type inclusion. That is, alumina adhering to the region P is a part of the B-type inclusion contained in the workpiece W, and it is considered that alumina contained in the workpiece W during the cutting work has been melted and deposited on the region P of the edge of the tool body 51 after the work.

The deposited material C1 deposited on the region P coats the region P and plays a role as a protective coating that suppresses transfer of the cutting heat, which is generated during the cutting work, to the edge. That is, since the deposited material C1 that contains alumina as the main component coats the edge of the ring-shaped tool 50, wear of the edge can be suppressed. Just as described, the cutting apparatus 1 cuts the workpiece W while the edge is coated with the deposited material Cl containing alumina as the main component. Therefore, tool life of the ring-shaped tool 50 can be extended.

In regard to a deposited material C deposited on the edge of the tool body 51 after the cutting work, a main component of a deposited material C2 that is deposited on a region Q of the outer circumferential surface 53 and the end surface 54 is a silicon oxide. The region Q is located away from the cutting edge 55 when compared to the region P. A main component of a deposited material C3 that is deposited on a region R of the outer circumferential surface 53 and the end surface 54 is an iron oxide. The region R is further located away from the cutting edge 55 when compared to the region Q.

A melting point of the silicon oxide is lower than a melting point of alumina, and a melting point of the iron oxide is lower than the melting point of the silicon oxide. Thus, it is considered that the cutting heat generated in the worked portion of the workpiece W by the ring-shaped tool 50 reaches a temperature that is lower than the melting point of alumina and higher than the melting points of the silicon oxide and the iron oxide and that the silicon oxide and the iron oxide deposited on the region P are melted by the cutting heat generated during the cutting work.

That is, the cutting apparatus 1 cuts the workpiece W such that the temperature of the cutting heat generated in the worked portion of the workpiece W by the ring-shaped tool 50 is lower than the melting point of alumina and higher than the melting points of the silicon oxide and the iron oxide. In this way, the cutting apparatus 1 can leave alumina deposited on the region P while melting the silicon oxide and the iron oxide deposited on the region P by the cutting heat. As a result, the region P (the cutting edge 55 and the portions near the cutting edge 55) can be coated with the deposited material C1, which contains alumina as the main component.

A crystal structure of alumina deposited on the region P is α-alumina. Meanwhile, a crystal structure of alumina contained in the workpiece W after the thermal treatment is γ-alumina. That is, it is considered that γ-alumina contained in SUJ2 is heated by the cutting heat generated during the cutting work and is transformed from γ-alumina into α-alumina. Here, α-alumina is superior to γ-alumina in terms of heat resistance and wear resistance, and α-alumina as the protective coating that coats the edge is advantageous to the extension of the tool life of the ring-shaped tool 50 when compared to γ-alumina.

In general, the cutting tool is worn sooner as the cutting heat generated in the worked portion during the cutting work is increased. Thus, it is common to limit the rotation speed and the feed speed of the cutting tool so as to prevent the cutting heat generated in the worked portion from becoming excessively high during the cutting work. That is, in the conventional cutting work, such an idea is normal that the cutting tool is worn sooner when the cutting work is performed under such working conditions (for example, the rotation speed and the feed speed) that the cutting heat reaches a temperature at which γ-alumina is transformed into α-alumina.

Meanwhile, in the cutting apparatus 1, the rotation speed and the feed speed of the ring-shaped tool 50 are set to such a rotation speed and such a feed speed that the cutting heat reaches the temperature (a transformation point) at which γ-alumina is transformed into α-alumina. In this way, the cutting apparatus 1 cuts the workpiece W while α-alumina is deposited on the edge. As a result, in the cutting apparatus 1, it is possible to reduce a time required for the cutting work on the workpiece W by setting the rotation speed and the feed speed at high speeds, and the wear of the edge can be reduced by coating the edge of the tool body 51 with the deposited material C1, which contains α-alumina as the main component. Therefore, the cutting apparatus 1 can achieve both of the extension of the tool life of the ring-shaped tool 50 and improvement in working efficiency.

In this embodiment, in the cutting apparatus 1, the rotation speed and the feed speed of the ring-shaped tool 50 are set to such a rotation speed and such a feed speed that the cutting heat reaches the transformation point (for example, 1000 degrees Celsius or higher), and the cutting apparatus 1 cuts the workpiece W while the deposited material C1 containing α-alumina as the main component is deposited on the region P. The temperature at which γ-alumina is transformed into α-alumina may differ by the workpiece W. Accordingly, the rotation speed and the feed speed of the ring-shaped tool 50 may be set to such speeds to sufficiently generate the cutting heat, the temperature of which is sufficiently high to transform γ-alumina contained in the workpiece W into α-alumina. In addition, the heat generated in the worked portion may be determined in accordance with the workpiece W.

The ring-shaped tool 50 includes the ring-shaped cutting edge 55, and the cutting apparatus 1 cuts the workpiece W while rotating the ring-shaped tool 50. Thus, a portion of the cutting edge 55 that comes into contact with the workpiece W is changed with the rotation of the ring-shaped tool 50. Accordingly, the portion of the cutting edge 55 that contacts the workpiece W and the deposited material C deposited in such a portion are cooled from time at which the portion and the deposited material C are separated from the workpiece W to time at which the portion and the deposited material C come into contact with the workpiece W again. In this way, the ring-shaped tool 50 can suppress the transfer of the cutting heat to the tool body 51. Therefore, the tool life of the ring-shaped tool 50 can be extended.

In addition to the above, the portion of the cutting edge 55 that contacts the workpiece W is changed with the rotation of the ring-shaped tool 50. Thus, compared to a so-called built-up edge resulted from a case where a particular portion of the cutting edge 55 continuously contacts the workpiece W as in single-point processing, it is possible to suppress thickening of the portion where the deposited material C1 deposited in the region P. Thus, in the cutting work using the ring-shaped tool 50, it is possible to suppress a shape of the edge of the ring-shaped tool 50 from being changed by the deposited material C1 deposited on the region P. As a result, in the cutting work using the ring-shaped tool 50, it is possible to maintain cutting accuracy of the workpiece W by the ring-shaped tool 50.

As it has been described so far, the cutting apparatus 1 cuts the workpiece W while alumina, which is contained in the workpiece W during the cutting work, coats the region P including the cutting edge 55 and the portions of the outer circumferential surface 53 and the end surface 54 near the cutting edge 55. As a result, in the cutting apparatus 1, with the deposited material Cl which contains alumina as the main component, it is possible to suppress the transfer of the cutting heat to the region P even in the case where the cutting heat which is generated in the worked portion during the cutting work is increased by setting the rotation speed and the feed speed of the ring-shaped tool 50 at the high speeds. That is, in the cutting work using the ring-shaped tool 50, while the rotation speed and the feed speed of the ring-shaped tool 50 are set to the high speeds, it is possible to suppress the early wear of the cutting edge 55 as the edge of the ring-shaped tool 50, the outer circumferential surface 53 as the rake face, and the end surface 54 as the flank. Therefore, it is possible to achieve both of the improvement in the working efficiency and the extension of the tool life.

In addition, the cutting apparatus 1 sets the rotation speed and the feed speed of the ring-shaped tool 50 to the high speeds such that the cutting heat exceeding the temperature at which γ-alumina is transformed into α-alumina is generated. Thus, the working efficiency of the workpiece W can be improved. Therefore, the cutting work using the ring-shaped tool 50 can achieve both of the improvement in the working efficiency and the extension of the tool life.

In the above first embodiment, the deposited material may adhere to the end surface 54. When the deposited material deposited on the end surface 54 is thickened, a clearance between the worked surface of the workpiece W and the deposited material deposited on the end surface 54 is reduced. Then, when the deposited material, which is deposited on the end surface 54 during the cutting work, comes into contact with the worked surface of the workpiece W, abrasions are produced on the worked surface of the workpiece W. In addition, due to abrasive heat that is generated by contact of the worked surface with the deposited material deposited on the end surface 54, residual stress in a tensile direction (tensile residual stress) is generated in the worked surface. That is, in a state where the residual stress in the tensile direction is generated in the worked surface, the worked surface of the workpiece W is likely to be cracked when the workpiece W is deteriorated by age or a high load is applied thereto. Just as described, the deposited material deposited on the end surface 54 can be a cause to lower quality of the workpiece W after the work. To handle such a problem, in a second embodiment, surface roughness of the end surface 54 is reduced. In this way, it is possible to suppress the deposited material from being deposited on the end surface 54. As a result, the cutting apparatus 1 can suppress the contact between the deposited material deposited on the end surface 54 and the worked surface during the cutting work. Thus, it is possible to prevent surface texture (roughness) of the worked surface of the workpiece W from being deteriorated. Here, the same components as those in the first embodiment described above will be denoted by the same reference numerals, and the description thereon will not be made.

In the tool body 51, the portion of the end surface 54 near the cutting edge 55 is mirror-finished, and the surface roughness of the mirror-finished portion of the end surface 54 is lower than the surface roughness of the outer circumferential surface 53. More specifically, in the tool body 51, while arithmetical surface roughness Ra of the outer circumferential surface 53 is set at 110 the arithmetical surface roughness Ra of the mirror-finished portion of the end surface 54 is set at 20 μm.

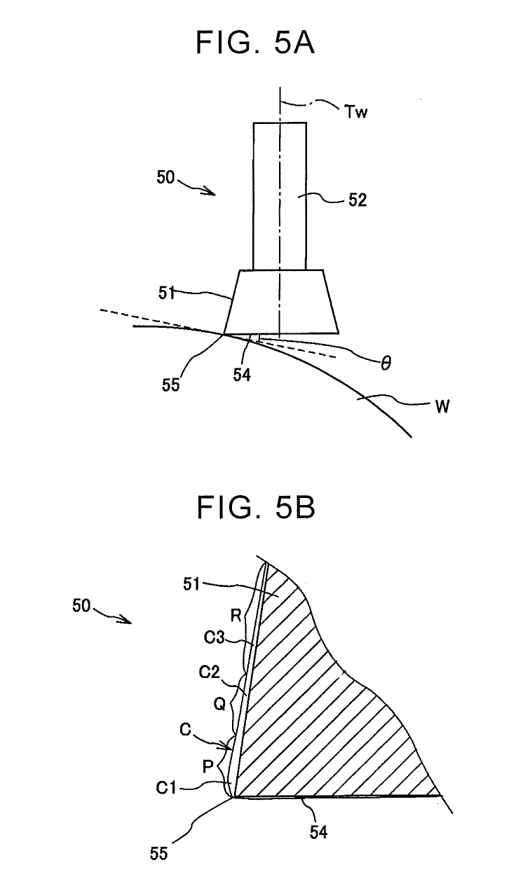

As shown in FIG. 5B, when the workpiece W is cut by the cutting method in the first embodiment described above, the deposited material C is deposited on the edge of the tool body 51 after the work. In regard to this point, in the tool body 51 in the second embodiment, the surface roughness of the mirror-finished portion of the end surface 54 is lower than the surface roughness of the outer circumferential surface 53. Thus, the deposited material is suppressed from being deposited on the mirror-finished portion of the end surface 54. As a result, the cutting apparatus 1 can suppress the contact between the deposited material deposited on the end surface 54 and the worked surface of the workpiece W. Therefore, it is possible to prevent the quality of the worked surface of the workpiece W after the work from being deteriorated.

The tool body 51 is made of CBN and thus is hard. Accordingly, a substantial amount of effort is required to mirror-finish the entire end surface 54. Meanwhile, in this embodiment, in the ring-shaped tool 50, the portion of the end surface 54 near the cutting edge 55, that is, the region in the end surface 54 on which the deposited material may be deposited during the cutting work is mirror-finished. Thus, a required area for the mirror finishing is limited. As a result, it is possible to reduce a time required for the mirror finishing on the ring-shaped tool 50.

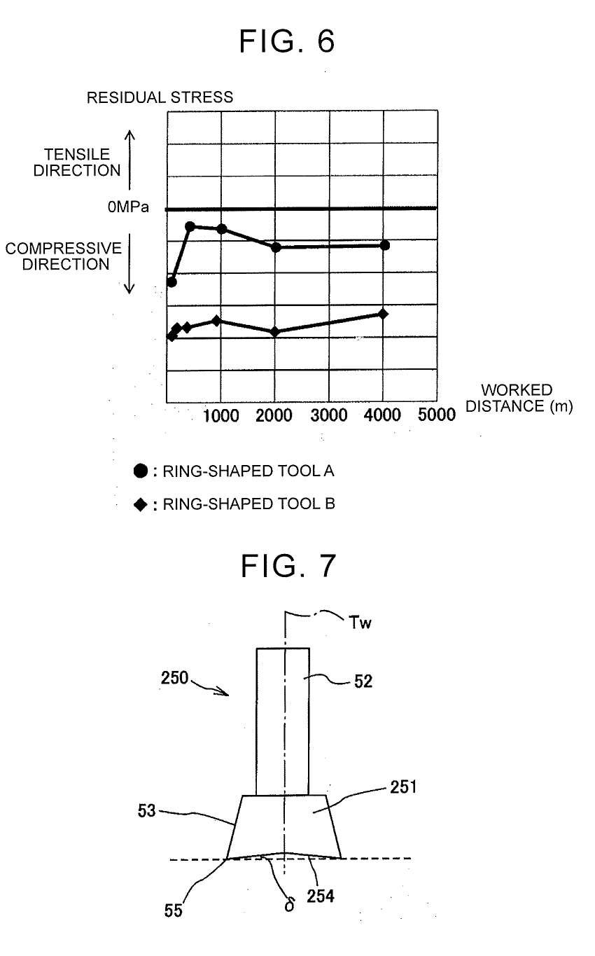

Referring to FIG. 6, a description will herein be made on a difference in the residual stress on the worked surface generated by a difference in the surface roughness of the end surface. FIG. 6 is a graph showing the residual stress on the worked surface of the workpiece W that is cut by using two ring-shaped tools A, B, each of which has the different arithmetical surface roughness Ra of the end surface from each other. A value of the arithmetical surface roughness Ra of the end surface of the ring-shaped tool B is approximately one-fifth of a value of the arithmetical surface roughness Ra of the end surface of the ring-shaped tool A. In FIG. 6, a vertical axis of the graph represents the residual stress, and a horizontal axis of the graph represents a working distance.

More specifically, in the graph shown in FIG. 6, the case where the residual stress exceeds 0 indicates that the residual stress in the tensile direction is generated on the worked surface. The case where the residual stress falls below 0 indicates that the residual stress in a compressive direction (compressive residual stress) is generated on the worked surface. Note that the residual stress is eliminated from the workpiece W prior to cutting by the thermal treatment. In addition, a state where the residual stress in the compressive direction is generated on the workpiece W is a state where fatigue strength of the surface of the workpiece W is high in comparison with a state where the residual stress in the tensile direction is generated on the workpiece W. Thus, the state where the residual stress in the compressive direction is generated on the workpiece W is preferred for the workpiece W.

As indicated by the graph shown in FIG. 6, there is a tendency that the residual stress in the compressive direction generated on the worked surface is higher in the workpiece W that is cut by using the ring-shaped tool B than in the workpiece W that is cut by using the ring-shaped tool A. The same tendency appears even when the working distance is increased.

As a result of examining the end surfaces of both of the ring-shaped tools A, B after the work, the thickness of the deposited material (a distance thereof from the cutting edge 55) that is deposited on the end surface of the ring-shaped tool B is less than that of the ring-shaped tool A. In addition, in the case where the ring-shaped tool A is used again for the cutting work after removal of the deposited material deposited on the end surface, the residual stress in the compressive direction generated on the workpiece W after the cutting work is increased to be higher than that on the workpiece W that is cut by using the ring-shaped tool A, from which the deposited material is not removed.

Just as described, for the cutting work using the ring-shaped tool 50, the end surface 54 of the tool body 51 is mirror-finished, so as to reduce the surface roughness of the end surface 54. In regard to this point, in the case where the end surface 54 is not mirror-finished, an origin of coating with the deposited material is likely to be set in an uneven portion of the end surface 54. As a result, coating the end surface 54 becomes easier (an anchoring effect). Meanwhile, in the ring-shaped tool 50 in this embodiment, the end surface 54 is mirror-finished, and thus unevenness of the end surface 54, which serves as the origin of coating, is reduced. Thus, the deposited material can be suppressed from being deposited on the end surface 54 during the cutting work. In this way, the cutting work using the ring-shaped tool 50 can suppress the contact between the deposited material deposited on the end surface 54 and the worked surface of the workpiece W. Therefore, the surface roughness of the worked surface of the workpiece W can be improved.

In addition, the cutting work using the ring-shaped tool 50 can suppress the generation of the abrasive heat, which is resulted from the contact between the deposited material deposited on the end surface 54 and the worked surface of the workpiece W. Thus, it is possible to suppress the generation of the residual stress in the tensile direction on the worked surface.

In other words, even in the case where the workpiece W, which has been cut by using the ring-shaped tool 50, is deformed by the heat or the like such that the residual stress in the tensile direction is generated on the workpiece WI, the state where the residual stress in the compressive direction is generated on the workpiece W can be maintained. Furthermore, even in the case where magnitudes of the residual stress generated on the worked workpieces W vary, it is possible to stably manufacture the workpieces W in the state where the residual stress in the compressive direction is generated thereon by the cutting work using the ring-shaped tool 50. Therefore, the quality of the workpiece W can be improved by the cutting work using the ring-shaped tool 50.

In this case, there is no need to provide a process of shot-peening the worked workpiece W so as to generate the residual stress in the compressive direction on the workpiece W. Therefore, manufacturing efficiency of the workpiece W can be improved by the cutting work using the ring-shaped tool 50.

As described above, in the ring-shaped tool 50 of the second embodiment, it is possible to suppress the deposited material from being deposited on the end surface 54 by reducing the surface roughness of the end surface 54.

In the second embodiment, the description has been made on the case where the deposition of the deposited material on the end surface 54 is suppressed by reducing the surface roughness of the end surface 54. In a third embodiment, the deposition of the deposited material on an end surface 254 is suppressed by setting the clearance angle θ, which is defined by the end surface 254 and the workpiece W, to be equal to or larger than a specified angle. Here, except for some of the components, the same components as those in the above embodiments will be denoted by the same reference numerals, and the description thereon will not be made.

As shown in FIG. 7, in a ring-shaped tool 250 of the third embodiment, the end surface 254 of a tool body 251 is formed in a tapered shape that is inclined in such a manner as to increase a clearance between the end surface 254 and an imaginary plane that is orthogonal to a rotation axis of the ring-shaped tool 250 and includes the cutting edge 55 as directed inward in a radial direction of the tool body 251 from the cutting edge 55. In the following description, an angle defined by the end surface 254 and the imaginary plane is defined as a tool clearance angle δ.

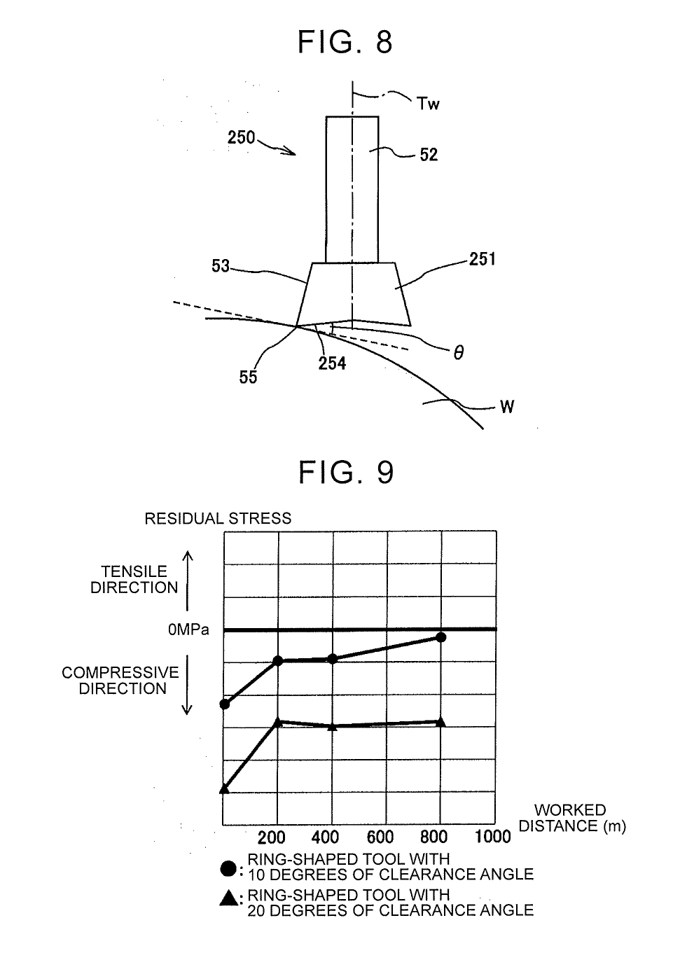

In this case, as shown in FIG. 8, in the cutting apparatus 1, while a rake angle defined by the outer circumferential surface 53 and the worked surface of the workpiece W is set at the same angle, the clearance angle δ defined by the end surface 254 and the worked surface of the workpiece W can be set to a larger angle than that in the ring-shaped tool (see FIG. 5A), the end surface of which is formed in a flat surface shape.

Accordingly, in the ring-shaped tool 250, a large clearance between the end surface 254 and the worked surface can be secured in a portion of the end surface 254 that is away from the cutting edge 55. Thus, the deposition of the deposited material on the end surface 254 can be suppressed during the cutting work. In addition, even in the case where the deposited material is deposited on the end surface 254, a large clearance is secured between the deposited material deposited on the end surface 254 and the workpiece W. Thus, the cutting work using the ring-shaped tool 250 can suppress the deposited material deposited on the end surface 254 from contacting the worked surface. Therefore, it is possible to prevent the surface texture (roughness) of the worked surface of the workpiece W from being deteriorated.

In addition, the cutting work using the ring-shaped tool 250 can suppress the generation of the abrasive heat, which is resulted from the contact between the deposited material deposited on the end surface 254 and the worked surface of the workpiece W. In this way, the cutting work using the ring-shaped tool 250 can suppress the generation of the residual stress in the tensile direction on the worked surface. Thus, the residual stress in the compressive direction can stably be generated on the worked surface of the workpiece W. Therefore, it is possible to extend life of the ring-shaped tool 250 and to improve the quality of the workpiece W by the cutting work using the ring-shaped tool 250.

The cutting work using the ring-shaped tool 250 can suppress the deposition of the deposited material while alumina contained in the workpiece W coats the region P. In this case, the cutting work using the ring-shaped tool 250 can suppress the transfer of the cutting heat, which is generated during the cutting work, to the cutting edge 55. Thus, it is possible to prevent early wear of the ring-shaped tool 250.

Referring to FIG. 9, a description will herein be made on the difference in the residual stress on the worked surface generated by a difference in the clearance angle θ. FIG. 9 is a graph showing the residual stress on the worked surface of the workpiece W that has been cut in a state where the clearance angle θ is set at 10 degrees by using the ring-shaped tool having the flat end surface and the residual stress on the worked surface of the workpiece W that has been cut in a state where the clearance angle θ is set at 20 degrees by using the ring-shaped tool, the tool clearance angle θ of which is 10 degrees. A vertical axis of the graph represents the residual stress, and a horizontal axis of the graph represents the working distance.

As indicated by the graph shown in FIG. 9, there is a tendency that the residual stress in the compressive direction generated on the worked surface is higher in the workpiece W that is cut by setting the clearance angle θ at 20 degrees than in the workpiece W that is cut by setting the clearance angle θ at 10 degrees. The same tendency appears even when the working distance is increased.

Just as described, in the cutting apparatus 1, the large clearance angle θ is set to suppress the deposition of the deposited material on the end surface 254. In this way, the high residual stress in the compressive direction can be generated on the worked surface of the workpiece W. In other words, even in the case where the workpiece W, which has been cut by using the ring-shaped tool 250, is deformed by the heat or the like such that the residual stress in the tensile direction is generated on the workpiece W, the state where the residual stress in the compressive direction is generated on the workpiece W can be maintained.

In this way, even in the case where the magnitudes of the residual stress generated on the worked workpieces W vary, it is possible to stably manufacture the workpieces W in the state where the residual stress in the compressive direction is generated thereon by the cutting method using the cutting apparatus 1. Therefore, the cutting apparatus 1 can stabilize the quality of the workpiece W that has been cut.

The disclosure has been described so far on the basis of the above embodiments. However, the disclosure is not limited to the above embodiments in any respect, and it can easily be conceived that various modifications and improvements can be made to the above embodiments within the scope that does not depart from the gist of the disclosure. In addition, the numerical values described in the above embodiments are merely examples, and other numerical values can also be applied.

For example, the description has been made on the case where the workpiece W is made of SUJ2 in each of the above embodiments. However, the workpiece W is not limited thereto. The cutting method according to the disclosure can be applied to the cutting work of the workpiece W other than SUJ2 as long as the workpiece W contains alumina. In addition, in the above embodiment, the description has been made on the case where the tool body 51 of the ring-shaped tool 50 is made from CBN as the example. However, the tool body 51 is not limited thereto. The tool body 51 may be made from a material other than CBN, such as cemented carbide or ceramics.

In the above embodiment, the description has been made on the case where the cutting apparatus 1 performs the cutting work by dry machining in which a coolant is not used. However, in the case where the cutting heat that is sufficiently high to produce alumina as the main component of the deposited material C1 deposited in the region P can be generated in the worked portion, the cutting apparatus 1 may perform the cutting work while the coolant is supplied. For example, in the case where the temperature generated in the worked portion during the cutting work exceeds the melting point of α-alumina, the cutting apparatus 1 may supply the coolant so as to adjust the temperature generated in the worked portion to be equal to or lower than the melting point of α-alumina.

For example, in the above second embodiment, the description has been made on the case where only the end surface 54 of the tool body 51 is mirror-finished. However, both of the end surface 54 and the outer circumferential surface 53 may be mirror-finished. In the cutting work, a magnitude of cutting resistance can be reduced by using the ring-shaped tool 50 in this case in comparison with the ring-shaped tool 50 in which the outer circumferential surface 53 is not mirror-finished.

Also, in this case, in the ring-shaped tool 50, the outer circumferential surface 53 and the end surface 54 may be mirror-finished such that the surface roughness of the outer circumferential surface 53 becomes greater than the surface roughness of the end surface 54. In such a case, in the ring-shaped tool 50, the deposition of the deposited material on the end surface 54 can be suppressed in comparison with the outer circumferential surface 53. Accordingly, the cutting work can be performed using the ring-shaped tool 50 such that the deposited material having alumina as the main component coats the region P of the outer circumferential surface 53 while the contact between the deposited material deposited on the end surface 54 and the worked surface of the workpiece W is suppressed.

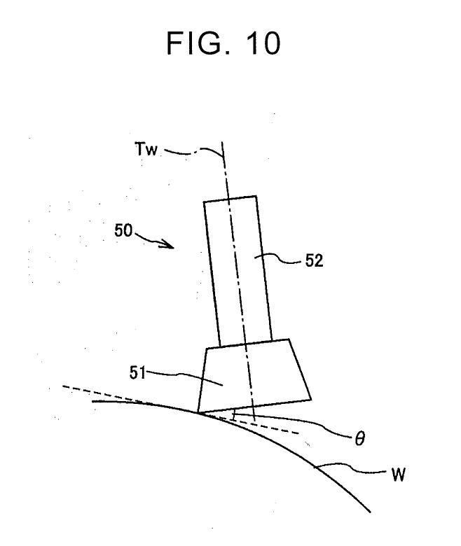

In the above third embodiment, the description has been made on the case where the clearance angle θ is secured by providing the tool clearance angle δ in the end surface 254 in the cutting work using the ring-shaped tool 250. However, the method for securing the clearance angle θ is not limited thereto. For example, as shown in FIG. 10, a posture of the ring-shaped tool 50 may be set such that the clearance angle θ becomes equal to or larger than the specified angle. For example, in the cutting apparatus 1, the large clearance angle θ can be set by adjusting an inclination of the rotation axis Tw of the ring-shaped tool 50.

The cutting work using the above ring-shaped tool 50 is performed while alumina contained in the workpiece W coats the cutting edge 55. Thus, it is possible to suppress the transfer of the cutting heat, which is generated during the cutting work, to the cutting edge 55. Therefore, the early wear of the ring-shaped tool 50 can be suppressed by the cutting work using the above ring-shaped tool 50.

For this reason, it is possible to suppress the deposition of the deposited material during the cutting work using the above ring-shaped tool 50. In this way, the cutting work using the above ring-shaped tool 50 can suppress the contact between the deposited material deposited on the end surface 54 and the worked surface of the workpiece W. Therefore, the surface roughness of the worked surface of the workpiece W can be improved. In addition, the cutting work using the above ring-shaped tool 50 can suppress the generation of the abrasive heat, which is resulted from the contact between the deposited material deposited on the end surface 54 and the worked surface of the workpiece W. Thus, it is possible to suppress the generation of the residual stress in the tensile direction on the worked surface.

In such a case, in the case where a roughing process of roughing the workpiece W and a finishing process of finishing the workpiece W that has been roughed in the roughing process are performed in the cutting work by the ring-shaped tool 50, the clearance angle θ in the finishing process may be set larger than the clearance angle θ in the roughing process.

In such a case, in the cutting work using the above ring-shaped tool 50, the rake angle, which is defined by the outer circumferential surface 53 and the worked surface of the workpiece W, can be set to be larger in the roughing process than in the finishing process. Thus, the cutting resistance can be reduced. Meanwhile, the larger clearance angle θ can be set in the finishing process than in the roughing process. Thus, in the cutting work using the above ring-shaped tool 50, it is possible to suppress the deposition of the deposited material on the end surface 54 in the finishing process.

What is claimed is:

1. A cutting method for cutting a workpiece by using a cutting tool having a ring-shaped cutting edge, the workpiece containing alumina, the cutting method comprising:
cutting the workpiece with the cutting edge being coated with alumina contained in the workpiece, wherein
an end surface of the cutting tool is set as a flank, and an outer circumferential surface of the cutting tool is set as a rake face.

2. The cutting method according to claim 1, wherein:
the workpiece contains γ-alumina, and
when the workpiece is cut by the cutting edge, heat at a temperature exceeding a temperature at which γ-alumina is transformed into α-alumina is generated.

3. The cutting method according to claim 1, further comprising:
cutting the workpiece with the outer circumferential surface being coated with alumina.

4. The cutting method according to claim 1, further comprising:
cutting the workpiece with the end surface of the cutting tool being coated with alumina.

5. The cutting method according to claim 1, wherein
the end surface of the cutting tool is mirror finished.

6. The cutting method according to claim 1, wherein
surface roughness of the end surface is less than surface roughness of the outer circumferential surface.

7. The cutting method according to claim 1, wherein
the end surface of the cutting tool is inclined such that a clearance between the end surface and a plane that is orthogonal to a rotation axis of the cutting tool and includes the ring-shaped cutting edge increases toward a radially inward side of the cutting tool.

8. The cutting method according to claim 1, further comprising:
setting a posture of the cutting tool with respect to the workpiece such that a clearance angle between the end surface and the workpiece becomes equal to or larger than a specified angle.

9. The cutting method according to claim 8, further comprising:
roughing the workpiece; and
finishing the workpiece that is roughed, wherein
a clearance angle when the workpiece is being finished is set to be larger than a clearance angle when the workpiece is being roughed.

10. A cutting tool for cutting a workpiece, the cutting tool comprising:
an outer circumferential surface as a rake face;
a ring-shaped cutting edge; and
an end surface as a flank when the workpiece is cut, the end surface being mirror-finished.

11. The cutting tool according to claim 10, wherein
surface roughness of the end surface is less than surface roughness of the rake face.

12. A cutting tool for cutting a workpiece, the cutting tool comprising:
an outer circumferential surface as a rake face;
a ring-shaped cutting edge; and
an end surface as a flank when the workpiece is cut, wherein
the end surface of the cutting tool is inclined such that a clearance between the end surface and a plane that is orthogonal to a rotation axis of the cutting tool and includes the cutting edge increases toward a radially inward side of the cutting tool.
